(19) United States
(12) Patent Application Publication
(10) Pub. No.: US 2008/0034869 A1
(43) Pub. Date: Feb. 14, 2008

(54) Method and device for imaged representation of acoustic objects, a corresponding information program product and a recording support readable by a corresponding computer

(76) Inventors: Gerd Heinz, Berlin (DE); Dirk Dobler, Friedersdorf (DE); Swen Tilgner, Berlin (DE)

Correspondence Address: NORRIS, MCLAUGHLIN & MARCUS, P.A., 875 THIRD AVE, 18TH FLOOR, NEW YORK, NY, 10022, US

(21) Appl. No.: 10/543,950

(22) PCT Filed: Jan. 30, 2004
(86) PCT No.: PCT/EP04/00857

§ 371 Date: May 26, 2006

(30) Foreign Application Priority Data
Jan. 30, 2003 (DE) 10304215.6

(51) Int. Cl. G01H 3/12

(52) U.S. Cl. 73/572

(57) ABSTRACT

The invention relates to a method and device for imaged representation of acoustic objects by taking acoustic cards with the aid of an acoustic set to which a reference image of a measure object is associated. Said invention also relates to an information program product and to a recording support which is readable by a corresponding computer and can be used, in particular for photographic and filmic documentation and for acoustic analysis of noise sources, for example of machines, devices and vehicles. For this purpose an acoustic camera is used. Said camera consists of a microphone assembly of an integrated video camera, a data recording unit connected to a microphone and to an angular sensor, a calibration device and a computer. Said video camera makes it possible to automatically document each measure in such a way that photographic records made by the camera are recorded and inseparably united in a dataframe with recording of the time function of the microphone associated with time-dependent synchronization signals, with all information on a scene and files of the microphone parameters and the data recording device. A time function, a frequency function, acoustical pressure, coordinates, tonality or the correlation with a known time function can be called for each point of an acoustic image by means of a mouse click on said point and a menu called by the mouse right button. Said acoustic camera is also provided with other functions such as automatic illumination which make it possible to select different methods (absolute, relative, manual, minus Delta, Lin/Log, all effective value, pic) for adequately pre-setting a minimum and maximum of a colour scale.

The invention describes a process and a device for imaging acoustic objects by using a microphone array to record acoustic maps which have a reference image of the measured object associated with them, and a corresponding computer program product and a corresponding computer-readable storage medium having the features of claims 1, 36, 52, and 53, which can be used especially for photographic and film documentation and for acoustic analysis of sources of noise, for example machines, equipment, or vehicles.

The invention can be used to prepare acoustic photos or acoustic films, frequency-selective images, spectra of certain sites, and acoustic images of passing objects from different distances.

The most varied processes are known for determining or depicting acoustic emissions (DE 3918815 A1, DE 4438643 A1, DE 4037387 A1, DE 19844870 A1, WO 85/02022, WO 9859258, WO 9845727 A, WO 9964887 A, WO 9928760 A, WO 9956146 A, WO 9928763 A, WO 11495 A, WO 10117 A, WO 9940398 A, WO-A-8 705 790, WO 85/03359, U.S. Pat. No. 5,258,922, U.S. Pat. No. 5,515,298); Heckl, M., Müller, H A.: Taschenbuch der technischen Akustik [Handbook of engineering acoustics], 2nd edition, Berlin-Heidelberg-New York, Springer-Verlag: 1995; Michel, U. Barsikow, B., Haverich, B., Schüttpelz, M.: Investigation of airframe and jet noise in high-speed flight with a microphone array. 3rd AIAA/CEAS Aeroacoustics Conference, 12-14 May 1997, Atlanta, AIAA-97-1596; Hald, J.: Use of Spatial Transformation of Sound Fields (STSF) Techniques in the Automotive Industry. Brüel & Kjaer, Technical Review No. 1-1995, pp. 1-23; Estorff, O. v., Brügmann, G., et al.: Berechnung der Schallabstrahlung von Fahrzeugkomponenten bei BMW [Calculating sound radiation of vehicle components at BMW]. Automobiltechnische Zeitschrift [ATZ], 96 (1994) issue 5, pp. 316-320), Brandstein, M., Ward, D.: Microphone Arrays. Springer-Verlag: 2001, ISBN 3-540-41953-5.

The disadvantage of known techniques is that they allow practically no measurement in the industrial routine. They are very time-consuming to set up and take down, as is the preprocessing and postprocessing of the pictures. A sound map and a photograph are associated by manually superimposing a sketch or a photograph of the object. The equipment is large and unwieldy. It is possible to make errors in evaluation. Only large objects can be mapped. Movies cannot be calculated. In particular, the known, manual superposition of the optical and acoustic data presents many possibilities for error.

Building on a field reconstruction based on the so-called Heinz interference transformation (HIT), since March 1996 the applicant has developed sound images which have new qualities, e.g., the ability to calculate nonstationary sources, see http://www.acoustic-camera.com [symbol] Projects. Thus, it is possible to make ultra-slow motion shots, for example, as well as sound photographs of a noise-emitting object. The first time in the world that an acoustic image had ever been superimposed on a video image was presented to the public by the team in 1999, see article at http://www.acoustic-camera.com [symbol] Press: Hannover trade show, MesseZeitung (MZ), Apr. 24, 1999, p. 4, “Sixteen ears hear more than two”. Since then, the process has been further developed and tested to the extent that it is simple to develop sound images, spectral images, and sound films in the entire range of engineering objects under industrial conditions.

The object of the invention is to describe a process and a device for imaging documentation of acoustic objects which makes it quick and simple to localize and analyze noise sources in industrial routine. It should make available an easily set up device (“acoustic camera”) for the most varied applications and different sized objects between a shaver and an airplane and which can be used to produce acoustic still images, acoustic films, spectral images, or linescans. A specific data structure should make it possible to recalculate pictures without mistakes, even years later. Acoustic images should be correctly “exposed” in a fully automatic manner. It should be possible to use it to investigate a multitude of engineering objects by providing specific modularity. This device should always be small enough to fit in the trunk of a passenger vehicle, and it should be possible to set it up and take it down in a few minutes. Independent of the basic algorithm that is used to reconstruct the time functions, the invention should reveal a novel measuring device. Each measurement should be automatically documented by a photograph, in order to avoid evaluation errors. The device should be as resistant as possible to interference or noise sources not lying in the image field.

The inventive object is accomplished by the features in the characterizing part of claims 1, 36, 52, and 53, in combination with the features in the preamble. Expedient embodiments of the invention are contained in the dependent claims.

A special advantage of the inventive process for imaging acoustic objects is that it makes it quick and simple to localize and analyze noise sources in the industrial routine by arranging the microphone array and an optical camera in a specifiable position to one another and automatically documenting at least part of the measurements with the optical camera, superimposing the acoustic map and the optical image by having the object distance and the camera's aperture angle define an optical image field on which the acoustic map is calculated, storing calculation-relevant parameters of the microphones and the camera of an array in an unmistakable way in a parameter file associated with the array, storing amplifier parameters in one or more parameter file(s) which are associated with the amplifier modules or the data recorder, giving the microphone array and the amplifier modules or data recorder each electronic signatures which unmistakably load the corresponding parameter files, decomposing the calculated acoustic image field into subareas whose centers of gravity represent the coordinates of the pixels to be calculated, optimally exposing acoustic maps by selecting various methods (absolute, relative, manual, minus_delta, lin/log, all, effective value, peak) to specify the suitable minimum and maximum of a color scale, eliminating synchronization errors of all microphones and amplifier channels by compensating the pictures with corresponding parameters from the parameter files of the microphone array and the data recorder, and storing records of the camera pictures and the associated records of the microphone time functions, time synchronization signals, scene information, and parameter files of the microphone array and the data recorder together with information about this association. Here it is especially advantageous if the records of the camera pictures are stored in a data file in which they are inextricably merged with the records of the microphone time functions, the time synchronization signals, all the scene information, and the parameter files of the microphone array and data recorder.

A device for imaging acoustic objects using a microphone array to record acoustic maps which have a reference image of the measured object associated with them is advantageously made by integrating an optical camera into the microphone array to form a unit, and having the microphone array, a data recorder, and a data processing device exchange microphone data, camera image(s), and time synchronization information through means of data transfer. Here it is especially advantageous if the acoustic camera is a video camera and the data processing device is a PC or notebook.

A computer program product for imaging acoustic objects comprises a computer-readable storage medium that has a program stored on it which, once it has been loaded into a computer's memory, allows the computer to image acoustic objects using a microphone array to record acoustic maps which have a reference image of the measured object associated with them in an imaging process comprising the steps described in one of claims 1 through 26.

In order to perform a process for imaging acoustic objects, it is advantageous to use a computer-readable storage medium that has a program stored on it which, once it has been loaded into a computer's memory, allows the computer to image acoustic objects using a microphone array to record acoustic maps which have a reference image of the measured object associated with them in an imaging process comprising the steps described in one of claims 1 through 26.

A preferred embodiment of the inventive process provides that the microphone array has a permanently built-in video camera which automatically records an image or a sequence of images at every measurement, or which supplies images continuously in video mode or in oscilloscope mode.

Another preferred embodiment of the inventive process generates acoustic still images and films by marking an interval in the time function display of the microphones, decomposing this interval into sections corresponding to the processor's cache structure, and averaging its frames into an overall image.

It has turned out to be advantageous if, for calculation of a film, the length of the sections is specified through the selected image frequency and if a single image is produced of each section; a factor can be specified to select how many sections should be averaged into one image each.

Another advantage of the inventive process is that the acoustic map is displayed with a color table by superimposing a color acoustic map on a video image whose edges can be extracted by means of an edge operator and/or which can be adapted by means of contrast or grayscale controllers. A special embodiment provides that the superposition of an acoustic map and a video image is controlled by having menu buttons which make it possible to turn on various views (edge image, grayscale image, video image, acoustic map); a slider controls the respective threshold value of the edge operator or the contrast or the grayscale of the video image.

It has also turned out to be advantageous if the time function, frequency function, sound pressure, coordinates, sound, or correlation with a known time function can be called up for every point in the acoustic image through a menu which is opened by right clicking on this point. Another advantage is that one window is used to select a frequency interval and a second window is used to display the associated spectral image, or that the second window is used to select a spectral range, whose acoustic image is in turn displayed in the first window. It is also advantageous if a time function correlation image is formed by calculating an acoustic photograph and correlating the reconstructed time functions of the pixels with the selected time function, and displaying this result in another window. Another preferred embodiment provides that in the modes “acoustic photograph” and “linescan” a video image is taken at the time point of the triggering and the trigger time point is shown in the time functions.

In another preferred embodiment of the inventive process, the PC, data recorder, and video camera exchange time synchronization information, which provides the time assignment between the video image and the time functions of the microphones.

An advantageous embodiment of the inventive arrangement is characterized in that all microphone data of an array is fed through a common connection (cable or bus) and a common one or more-part plug to the data recorder, and/or that the video camera's lead is also integrated into this common connection line.

Another preferred embodiment of the inventive arrangement provides that a microphone array contains a signature chip in the plug connected to the data recorder.

Moreover, it turns out to be advantageous for microphone arrays having a different number of channels to be pin-compatible, allowing them to be connected to a data recorder through the same one or more-part plug type that is identical for various arrays; unused inputs in the plug can be shorted under some circumstances.

Special embodiments of the inventive arrangement are characterized in that an acoustically transparent microphone array for two-dimensional indoor measurements advantageously consists of a video camera and microphones arranged at equal distances on a ring, or that an acoustically reflective microphone array for two-dimensional indoor measurements advantageously consists of a video camera and microphones arranged at equal angles around a circular surface; a portable case embodiment has the data recorder integrated in it; or that a microphone array for three-dimensional measurements in chambers is advantageously made in the form of a spherical ruled surface having the microphones uniformly distributed on its surface. Means of data transfer are provided in the form of cable connections, radio connections, or infrared connections.

The invention is explained in greater detail below in sample embodiments.

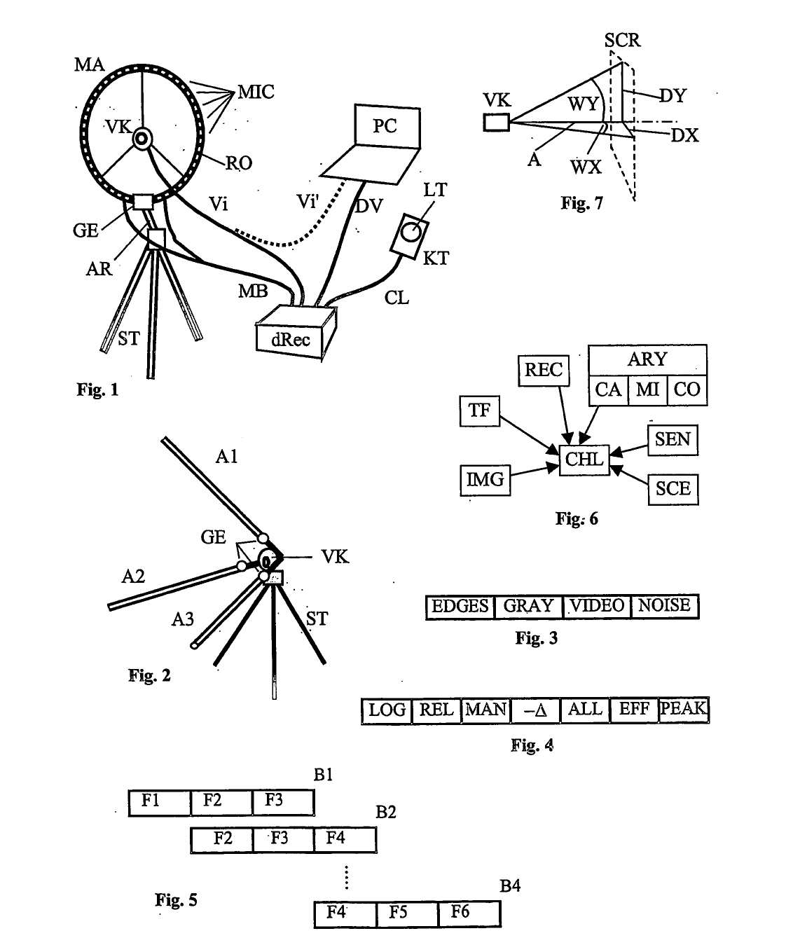

FIG. 1 shows a diagrammatic representation of a typical embodiment of the inventive device for measurements on motors. Microphones MIC of microphone array MA are uniformly distributed in a circular tube RO which is fastened to a tripod ST by a joint GE and an arm AR. They are connected to a data recorder dRec through a connection MB. A video camera VK is connected to the data recorder dRec through a connection Vi, or, alternatively, directly to the computer PC through a connection Vi′. Data recorder dRec is connected, through a connection CL, to a calibration tester KT, which contains a speaker LT. The computer PC and the data recorder have a data connection DV between them. A modification would result from integrating the data recorder dRec into the microphone array.

FIG. 2 shows a special embodiment of a microphone array for remote sensing which is mounted on a tripod ST and which is collapsible. Microphones are located in arms A1 through A3. These can pivot about locking joints GE, so that the collapsed system can be transported in a passenger vehicle. Once again, the system has a video camera VK permanently integrated into it.

FIG. 3 shows a typical menu for image superposition operations. The acoustic map can be turned on and off with a button NOISE, and the video camera image can be turned on and off with a button VIDEO. The colors can be removed from the video image with a button GRAY, and a button EDGES performs edge extraction on the video image; when GRAY or EDGES are used, sliders are provided for brightness and contrast, or for edge width.

FIG. 4 represents typical menus for scaling the color table of the acoustic map. A button LOG switches between linear and logarithmic scaling of the color table of the acoustic image. A button ABS makes it possible to scale a complete film between the absolute minimum and maximum sound pressures. The button REL scales each individual image of a film separately to the maximum relative contrast. A button MAN opens two input windows in which the maximum and minimum can be specified manually. A button -A allows automatic color scaling of the acoustic image. It opens an input window to input a difference by which the minimum is lowered with respect to the maximum present in an image. A button ALL makes it possible to transfer a selected maximum and minimum to other images or films. An effective value image is turned on with the button EFF, while the button PEAK displays a peak-evaluated image.

FIG. 5 is a diagrammatic illustration of an advantageous process step for developing acoustic films that saves computing time. According to the selected image frequency, an area, selected in the channel data, of a calculated film is divided into frames F1 to F6. In an input window an image overlap is selected (in the example equal to three). The first image B1 is calculated from the first three frames F1 through F3 by a forming a moving average. The second image B2 is calculated from frames F2 through F4, etc. Thus, 6 frames produce 4 consecutive images B1 through B4 of a film. When this is done, video images are associated with the frames in such a way that one video image belongs to each frame. In slow-motion representations, in which the framerate is higher than the selected video image rate, the last video image always continues to be associated with consecutive frames until a next video image is ready. This method avoids calculating acoustic frames multiple times, once they are calculated. Also, the image overlapping factor can be adjusted to make the image sequences as free of jerkiness as desired.

FIG. 6 is a diagrammatic illustration of the information to be stored in a measurement data file CHL. The meanings of the abbreviations are as follows: TF time functions, including the sampling rate; IMG the individual image or video images of a sequence; REC the amplifier parameters of each microphone channel; ARY the parameters of the array, which are composed, in particular, of possible apertures and pixel resolutions of the video camera CA, identification sensitivities and loci of the microphones MI, and coordinates and orientations CO of the camera and microphones. Also stored in it are the current scene parameters SCE such as the aperture, the measurement distance, air pressure, and temperature, as well as transfer factors and parameters of special channels SEN. The data types REC, ARY, and SEN are taken from specific, prestored files; the parameter files REC and ARY are produced once in the calibration process, and the type SEN varies as a function of the session.

FIG. 7 shows how coordinates of a virtual image field SCR are obtained from the aperture angles WX and WY and the object distance A. WX, WY, and A are used to determine the segments DX and DY, which are used to determine the coordinates of the image field.

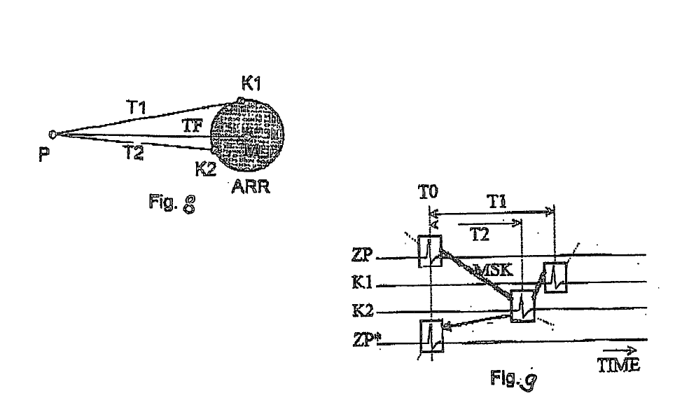

FIG. 8 shows the spatial arrangement of the microphones K1 through KN in an array ARR.

FIG. 9 illustrates the time displacement of the curve of the time function ZP in microphone channels K1 and K2.

Acoustic maps are difficult to read if no reference image of the measured object is superimposed on them. Manual superposition using reference points is time-consuming and very prone to error. If the scenes are moving (if the film is a series of photographs) or if the experimental setup is unknown, it is almost impossible. The invention overcomes this difficulty by integrating into every microphone array a (digital) video camera which takes a photograph or a film for every measurement. The photographs are coupled to the data recorded by the microphones and stored or loaded together with it as a file. This data file also includes all measurement settings, parameters of the microphone array used, and parameters of the data recorder.

In order for operation to be as simple as possible, superposition of photograph(s) and map(s) should be made automatic. To accomplish this, the inventive process provides that the x- and y-aperture of the camera per meter is entered in a parameter file of the array. If the camera has several apertures, all possibilities are entered. The distance to the measured object is measured manually. The inventive procedure uses the camera's current aperture and the object's distance to determine the coordinates of the image field to be calculated. In addition, the image's raster resolution should be manually specified, e.g., along the x-axis. Then it is possible to calculate the image. When this is done, a single calculation is performed for each raster point. This allows the user to specify the computing time on the basis of the raster resolution: High raster resolution means long computing time.

If an acoustic camera is to be used on objects of different sizes from a shaver to an airplane, it must be light, compact, and robust, and must function reliably. This can only be achieved with a relatively small number of microphone channels (typically around 30). But now acoustic limits are set: The microphone distance must be on the order of magnitude of the desired, dominant wavelengths, otherwise outside interference phenomena interfere with the reconstruction (wave i interferes with the preceding wave i−1 or the succeeding wave i+1). Moreover, the array's aperture cannot be varied arbitrarily: If the array is kept too close to the object, microphone channels are partially shaded and cause errors. If too great an object distance is selected, the acoustic maps are too blurred. Since a large range of wavelengths (100 Hz≈3.4 meters to 100 kHz≈3.4 mm) is to be scanned, requiring a small number of channels means that the only remaining solution is to build different sizes of microphone arrays whose size, microphone distance, and shape are adapted to the respective objects to be mapped. Thus, three basic shapes were developed which can cover practically the entire acoustic range. To accomplish the object of the invention, it should also be taken into consideration that to avoid outside interference the microphones should have a stochastic arrangement, but to avoid locus errors they should have a regular and symmetrical arrangement with respect to the axes (2D: x, y or 3D: x, y, z). Three basic array shapes have proved themselves when used in the inventive process:

(1) For 3D surround mapping done inside (e.g., in passenger vehicles), an acoustically open, carbon fiber laminated, cubic icosahedral arrangement (“cube”) having a diameter of 30 cm and 32 channels is suitable. The array has excellent symmetry properties with regard to all three axes, and also shows good single-axis stochastic properties. The design can be identified from interlocking pentagonal and hexagonal figures.

(2) For 2D mapping of machines, a ring arrangement has proved itself very well. In this arrangement, the microphones are arranged at equal distances in a ring. An odd number of channels minimizes side lobes in the loci, while an even number has the best symmetry. The design can be acoustically open (a ring) or acoustically reflective (a wafer) given frequency-dependent ring diameters in the range from 10 cm to 1.5 m. While open ring arrays hear just as well from the front and the back, the back field is destroyed only with an array having a reflective design. Here the reflective surface lies in the plane of the microphone membranes. Arrays having circular arrangements exhibit the best symmetry properties with regard to two axes and the best single axis stochastic properties.

(3) For 2D mapping outside over great distances it is also necessary to consider the portability. Collapsible arrangements with an odd number (at least three) of microphone-carrying arms are especially suitable for this. Since these arrays are open, additional possibilities must be provided for backwards attenuation. The inventive process accomplishes this by having the arms not lie in a single plane in unfolded state. Compared with arrangements having four arms, the three-arm arrangement has better behavior with respect to outside interference. Balanced loci are achieved by a logarithmic distribution of the microphones on the arms.

Erroneous microphone coordinates produce erroneous calculation results: When using different microphone arrays, it turns out to be advantageous to record the positional coordinates of the microphone capsules, their serial numbers, the electrical characteristics, and the position and axial direction of the laser and camera in a parameter file associated with the array (passively in the form of an ASCII file or actively in the form of a DLL). This file should also contain the camera's aperture as a function of the selected resolution and the selected zoom lens. When interchangeable lenses are used, the file also contains the aperture of the respective lens type, so that the only things that still have to be indicated are the lens type and distance in order to uniquely assign the photograph in a virtual 3D coordinate system. This file is read when the software is started. A microphone array is given a digital signature chip which allows every array to be uniquely identified and assigned. The array's parameter file stores the following data about the camera and microphones: about the camera: camera type, driver type, serial number, resolution(s), lenses, aperture(s), and image rate(s). About every microphone: microphone type, serial number, identification sensitivity, coordinates of membrane center, 3D direction vector, loci of amplitude and delay time, as well as the number of channels and signature of the array. A parameter file of the data recorder stores the following: number of channels, amplification of all channels per amplification level, sampling rates, maximum recording depth, hardware configuration, and transducer transfer function.

All data belonging to a picture should be stored in an unmistakable manner and be available without errors for subsequent recalculations. To accomplish this, the microphone coordinates and orientation, identification sensitivities and loci, the current focus, the aperture used of the video camera, calibration data of the amplifier, camera and microphones and array, sampling rate, video image or video film, and time functions of all microphones and special channels are stored in a single data file. This file makes it possible to recalculate an older picture at any time, without requiring specific knowledge about this scene.

Simple processes should be devised for automatic assignment of an acoustic map and video camera image or manual assignment of a sketch and an acoustic map. Two assignment methods have proved their worth when used with the inventive process:

(1) Automatic: The distance to the object is manually specified in a dialog box. The distance and the video camera's lens aperture taken from the array parameter file determine the physical limits and coordinates of the calculated acoustic map. The selected video image format and the adjusted zoom format specifies the aperture WX, WY in tabular or numerical form. Together with the object distance A, these allow the physical coordinates of the image field to be determined.

(2) Manual: A known distance on a sketch and a known point are marked. These allow the calculated image field to be determined along with its coordinates.

In order to save computing time, it is efficient to divide the acoustic map manually into pixels to be calculated. To accomplish this, the calculated acoustic image field (a flat surface or 3D object) is decomposed into subareas. Their centers of gravity represent coordinates of pixels to be calculated. The interference value associated with the center of gravity colors this surface. The user specifies the number of pixels along the x- or y-axis in a dialog box, or specifies a 3D model that is triangularly decomposed in a corresponding manner.

In order to be able to use the device as a measurement instrument, a process should be developed which provides reproducible results. This is accomplished by reconstructing the time functions of the centers of gravity of the subareas in the selected interval. Their effective values characterize, e.g., the sound pressure of an equivalent isotropic radiator at an equal distance.

Video cameras have the property of providing images with pincushion distortion. Processes should be indicated which allow error-free superposition of video and sound images in all pixels of an image. In order to be able to make orthogonally undistorted, acoustic maps congruent [with such video images], conventional transformations must either distort the orthogonal acoustic image coming from the reconstruction or rectify the optical image. If the video camera is arranged off-center in the microphone array, the offset of the image at the respective object distance also has to be included in the calculation through a transformation.

Long waves produce muddy images with low sound pressure contrast. Methods should be indicated for exposure and sharpening the contrast which supply good images, even fully automatically. This can be accomplished by specific methods for adjusting the color table: With the calculation of each pixel, a global maximum and minimum for each acoustic map are calculated for each image. A menu function “REL” (relative contrast) sets the color table between the global maximum and global minimum for an individual acoustic map. This produces an acoustic map that is already recognizable. Another menu function “ABS” sets the color table between the maximum and minimum of an entire film. If a defined contrast ratio (e.g., −3 dB, or −50 mPa) is of interest, then it is advantageous (e.g., in films) to subtract an interactively adjusted value “minus delta” from maximum of the image to determine the minimum that should be displayed. As a default setting, this method, compared with the methods “ABS” and “REL”, supplies, in a fully automatic manner, high quality images and films in which the maxima can immediately be identified. If an image is supposed to be centered on a specified color table for comparison purposes, this is done manually by means of the menu function “MAN”. Selecting this menu function opens a double dialog box (for max and min). Another menu function “LOG” switches between a linear pascal display and a logarithmic dB display of the color table. If the emissions of several calculated images are to be compared, a menu function “ALL” is useful: It passes the color table settings of the current image to all other images.

Methods should be to developed to make it simple to generate acoustic still images (1) and acoustic films (2). The inventive process uses the following methods:

(1) To generate an individual acoustic image, the time interval of interest is marked in a time function window. It might be decomposed into smaller sections corresponding to the processor's cache structure. For each pixel the interference value is now determined and buffered. The respective image of a section is calculated in this way. The images of the sections are added with a moving average into the entire image of the calculation area and displayed. This can be recognized from the gradual composition of the resulting image. In the operating modes Live Preview or Acoustic Oscilloscope, the calculation area is not manually specified, but instead a default value is selected.

(2) To calculate an acoustic film, once again a time interval of interest is specified. Selection of an image frequency determines the time intervals for all individual images. Every section produces an individual frame. However, films calculated in this way still give a very choppy impression. For smoothing, a number of frames are averaged with one another. The number of images to be averaged is an interactively specified factor. In the same way, it is also possible to specify the image frequency and interval per image, to determine the factor from the interval width.

The digitized time functions are played backward in time in the computer in a virtual space which includes the microphone coordinates x, y, z. Interference occurs at the places which correspond to sources and sites of excitation.

To accomplish this, for each point to be determined on a calculated surface its distance to each microphone (or sensor) of the array ARR is determined. These distances are used to determine the propagation times T1, T2 to TN of the signals from the exciting site P to the sensors (microphones) K1, K2 to KN (FIG. 8). (TF is the propagation time for sound to travel between the center of the array—this can be the site at which the camera is positioned—and the point P.)

Each point to be determined on a calculated surface is given a tuple of time shifts or delay times (“mask”) which are associated with the microphones. If the channel data of the microphones is now compensatingly shifted along the time axis according to the mask of the calculated site, then simple, sample-wise algebraic combination of the time functions Z1, Z2 to ZN can approximate the time function ZP* at the site P to be determined. This process is known, but is not efficient: If one has to calculate many site points, then the relative shift of the individual channels to compensate the time shifts is too time-consuming.

It is more favorable to form the algebraic combination of the time functions to be determined for a site P and a time point T0 by accessing each element of the channel data shifted by the delays of the site mask. To accomplish this, the mask MSK must be laid in the channel data K1, K2, . . . KN in the direction of the passage of time. FIG. 9 shows the mask MSK of a site point P (with a time function ZP starting from P) in the channel data K1 and K2. The time shifts or delay times T1 to TN belonging to segments P-K1, P-K2, to P-KN in FIG. 8 between point P and microphones K1, K2, . . . KN form the mask of site P.

If we now access the channel data through the holes in the mask of P (symbolically speaking), this gives an approximation of the time function of the site P under consideration. From this time function it is normally possible to determine an effective value or maximum and minimum (in the form of a number), so this number is stored as a so-called interference value of the point.

It is now possible to use different numbers of samples of the channel data to determine an interference value. The spectrum ranges from one sample all the way to the full length of the channel data.

If one represents the resulting interference values for all points on a surface to be determined for all points to be calculated for only one point in time as gray or color values in an image, and if one continues to do this for all time points, then this produces a movie of the wave field running backwards. This is characterized in that the pulse peaks preceding in time inherently, contrary to our experience, lie inside circular wave fronts.

If this movie is calculated in direction of advancing time, the resulting wave field also runs backwards, and the waves draw together. If the calculation is done counter to the direction of time, the waves do propagate in the direction of our experience, but the wave front remains inside the wave.

By contrast, if one calculates the time function of a site P with its mask MSK for all time points, it is then possible to use common operators such as effective value, maximum, sigmoid etc., to determine an individual value for this site, that allows a statement about the mean level of the time function.

If interference values are determined for all points of an image, this produces a matrix of interference values. If the interference value in the form of a gray or color value is assigned to a pixel, we get, e.g., a sound image of the observed object.

An advantageous embodiment for measuring at great distances involves noting the result of the addition along the mask not at time point T0 of the time function ZP*, but rather noting this result at a time point Tx, so that the common delay time of all channels is eliminated. When this is done, the time difference Tx minus T0 is, e.g., selected just as large as the smallest delay between point P and a sensor (microphone) K1 through KN, in example T1.

If the medial propagation speed is varied, then one wants to have movies or images with a comparable time reference. To accomplish this, an advantageous embodiment consists of selecting the site Tx of the entry of the result of the mask operation in the middle of the resulting time function ZP*. To accomplish this, the time shift from which Tx can be determined is determined from half the difference of the largest mask value (e.g., TN) minus the smallest mask value (e.g., T1) of a site P lying in the center of the image field: Tx=T0+(TN−T1)/2.

Since we are dealing with digitized channel data, but the time intervals between P and the microphones are not expected to be integers, two types of roundings are provided: A first kind involves taking a sample of the respective channel that is nearest in each case. A second kind involves interpolating between two neighboring channel data samples.

The channel data can be processed in two ways. As one progresses in the direction of the time axis, although the wave fields do run backwards, the external time reference is maintained. This type is suitable for use if acoustic image sequences are supposed to be superimposed with optical ones. By contrast, if one progresses backwards on the time axis, then the wave fields appear to expand, producing the impression that corresponds to our experimental value.

Now we can, with the same device, also calculate (mostly mirror-image) projections with time constantly running forward, as is known from optics. To accomplish this, we need an additional offset register in which the delay compensation of the individual channels should be entered. The channel data are shifted a single time according to entered offsets, and stored again.

This offset register also performs services that are useful for calibrating the microphones. Small fluctuations in parameters can be balanced if all channel data received is compensated according to the offset register before storage.

Direct superpositions of an acoustic map and a video image are difficult to identify if both are in color. The inventive process allows different types of image superpositions to be set through menu buttons: “NOISE” acoustic map on/off, “VIDEO” video image on/off, “EDGES” edge extraction of video image on/off, “GRAY” grayscale conversion of video image on/off. A slider controls the threshold value of an operator for edge extraction or contrast or grayscale of the video image.

For the analysis of a machine various pieces of information are of interest, such as, e.g., time functions of various sites, sound pressure, coordinates, frequency function, or sound. Methods should be specified for efficient interaction between the site and the frequency or time functions. This is accomplished by making different menu entries available for certain methods:

(1) Mouse functions: A site in the acoustic image can be selected by moving the mouse. As the mouse pointer moves, it is constantly accompanied by a small window which optimally displays the sound pressure of the respective site or the current coordinates of the site. Right-clicking opens a menu containing the following entries:
Reconstruct time function of current site
Reconstruct frequency function of site
Display coordinates of site
Display sound pressure of site
Store as image (e.g., as JPG, GIF, or BMP), or as movie (e.g., as AVI or MPG)
Store as matrix of values in a special file format (image or movie)

(2) Listening to an image: Behind every pixel the reconstructed time function is buffered. If a menu function “Listen” is selected, the time function lying under the mouse pointer is output through the sound card; it may optionally repeat.

(2) Spectral image display: The computing option makes available two interacting windows: Image and Spectrum. Left-clicking in the Image window causes the spectrum of the clicked on site to be displayed in the other window. Marking a frequency interval there causes the image for the selected frequency interval to appear. To accomplish this, each image has a number of Fourier coefficients corresponding to the selected sample number stored behind it in the third dimension. The available storage options are photograph (e.g., JPG) and matrix of values of the current image, and matrix of values of all images of an area or movie of all images of an area (AVI).

(3) Difference image display: To begin with, a reference image in the form of a matrix of values also has to be loaded. The menu presents the option “Difference Image”. An acoustic image is calculated. The numerical difference is taken between the effective values of the image and the reference image, and from this difference the difference image is calculated and displayed.

(4) Time function correlation image display: To find a certain interference in an image, an acoustic image is calculated. The reconstructed time functions are buffered behind the pixels in the third dimension. In addition, an area of a time function should be suitably marked. If the option is selected, the cross correlation coefficients of all pixels are calculated with the marked time function and displayed as a resulting image.

(5) Spectral difference image display: To classify motors, for example, site-selective correlations between desired and actual states are of interest. To accomplish this, an image or spectral image is loaded as a reference image, and an image or spectral image of the same image resolution is calculated or loaded. The cross correlations of the time functions of the pixels are calculated in the time or frequency range and displayed as a result. A threshold value mask which can also be laid on the image also allows classification.

(6) Autocorrelation of image and film: If a sound is being sought and only its period is known, but not its time function, this method is the one to use. The menu option is selected. This opens a dialog box which prompts for the input of the period length that is sought. The reconstructed time function is now calculated pixel by pixel and autocorrelated with itself shifted by the period. The result coefficient is displayed in a manner known in the art.

The coordinates of arrays are imprecise in the millimeter range due to manufacturing tolerances. This can produce erroneous images if there are signal components in the lower ultrasound range. Measures should be take to prevent these errors. Using the inventive process it is possible to correct the coordinates of the microphones by means of a specific piece of calibration software. Starting from a test signal, a mean delay time is measured. This is used to correct the respective coordinates for each microphone in the initialization file of the microphone array.

Outside interference endangers the display of short waves at higher frequencies. In particular, various measures should be taken to synchronize all microphones and amplifier channels in the range of a sample. This is done by measuring all amplifier settings, propagation times, and frequency dependencies of the preamplifier with automatic measuring equipment. The data is stored in the parameter file of the recorder, and the time functions are compensated with the measurement data. The microphones are especially selected, and delay times are measured and stored in the array's parameter file together with the loci of various frequencies for compensation purposes. The coordinates of the microphone arrays are acoustically checked and corrected, if necessary.

It should be ensured that the precise superposition and orientation between video image and acoustic image can be checked before a measurement. To accomplish this, a calibration test of the system is carried out by means of a so-called clicker. This produces a test sound by means of a high-pitch speaker. The system works correctly if the acoustic map and the video image coincide at the speaker.

The microphone array, video camera, image field, and 3D objects need to have suitable coordinate systems determined. The inventive solution consists of working in a single coordinate system whose axes are arranged according to the right-hand rule. The microphone array and video camera form a unit whose coordinates are stored in a parameter file. The calculated image field is advantageously also determined in the coordinate system of the array. 3D objects generally come with their own relative coordinate system, and are integrated through corresponding coordinate transformations.

If acoustic images are made of complex objects, practically unforeseeable situations (too much noise from the surroundings, etc.) can have a substantial influence on the image quality. In order to prevent [this and ensure that] high-quality images are always produced, it is advantageous for there to be a viewfinder function (Live Preview) analogous to that of a camera. Repeatedly selectable time function pieces adapted to the problem and an associated photograph are collected and processed and calculated together into an acoustic viewfinder image, which is displayed. During the time it is being computed, new data is already being collected. As soon as the calculation has ended, the cycle starts over again. The viewfinder image is processed in exactly the same way as every other acoustic picture. The viewfinder function is automatically turned on when the viewfinder image window is opened and, depending on the computing power, allows a more or less fluid, film-like display of the surrounding noises at that moment in the form of a moving film.

Overdriving the microphone channels causes undefined additional delays of individual channels, which can substantially distort the acoustic image. Measures should be taken which make such a distorted picture identifiable, even later. The inventive process expediently monitors the level of the samples collected in the recorder for time functions through a software drive level indicator. In addition, when [the samples are] collected in the window of the time function display, a fixed scale is initialized which corresponds to full drive of the recorder's analog/digital converter (ADC). This makes it easy to identify underdrive or overdrive of the ADC, even during later evaluation of the picture.

Time functions can only be compressed with loss of information. To allow storage which is lossless yet still efficient, corresponding measures should be taken. The inventive process involves storing samples of time functions in a conventional sigma-delta format or in a special data format with 16 bits plus an offset that is valid for all samples of a (microphone) channel. In 16-bit analog/digital converters, the constant corresponds to the adjusted amplification of the preamplifier, and in converters having higher resolution (e.g., 24 bit) only the highest-order 16 bits and the offset are stored.

An acoustic camera should observe sound events which occur sporadically. Once the event appears, it is too late to trigger the camera. Therefore, the inventive process involves writing all time functions and images into a buffer having circular organization, which can be stopped at the time of the triggering (Stop Trigger) or which continues to run at the time of the triggering until a cycle is complete (Start Trigger).

Data recorders should use inexpensive, commercially available components. Therefore, the inventive process measures every channel of a data recorder with a signal generator. For the respective data recorder a device-specific parameter file or device driver is created which contains all current stage gains and the basic amplification of each channel. This file is loadable and is selected and loaded at the start of picture-taking.

It should be ensured that identification sensitivities, loci, and delays of the microphones and amplifier channels can be interpreted without mistake. To accomplish this, the total amplification of each channel is determined from the data in the initialization file of the microphone array (sensitivity of the microphones) and that of the recorder (adjusted amplification). The sound pressure of each channel is determined from the sample values of the ADC, taking into consideration the currently adjusted amplification.

External signals (special channels, e.g., voltage curves, pressure curves, etc.) often have to be collected together with the array's microphone time functions. However, their sources generally have a different drive. Therefore, the inventive process involves driving the array's microphones together with one controller, however all special channels are driven individually.

Special channels often serve different kinds of sensors, e.g., for voltage curve, current curve, and brightness. Later this can cause mix-ups. The inventive process involves storing one transfer factor per channel.

Parameters of the microphone array are generally invariable, while parameters of special channels often vary. The inventive process involves keeping the two kinds of parameters in separate files, in order to make it possible to reinitialize the array parameters.

Displaying the sound pressure in the time functions involves using the microphone constant. If the amplifier channels are checked, this produces readings of different levels. The inventive process involves making available a switching option for service tasks which makes it possible to display the voltage at the amplifier inputs (without microphone constant).

The invention is not limited to the sample embodiments presented here. Rather, it is possible, by combining and modifying the mentioned means and features, to realize other variant embodiments, without departing from the framework of the invention.

1-53. (canceled)

54. Process for imaging acoustic objects by using a microphone array to record acoustic maps which have a reference image of the measured object associated with them, characterized in that
the microphone array and an optical camera are arranged in a specifiable position to one another and the optical camera automatically documents at least part of the measurements;
the acoustic map and the optical image field are superimposed by having the object distance and the camera's aperture angle define an optical image field on which the acoustic map is calculated;
calculation-relevant parameters of the microphones and the camera of an array are stored in an unmistakable way in a parameter file associated with the array;
amplifier parameters are stored in one or more parameter file(s) which are associated with the amplifier modules or the data recorder;
the microphone array and the amplifier modules or data recorder are each given electronic signatures which unmistakably load the corresponding parameter files;
the calculated acoustic image field is decomposed into subareas whose centers of gravity represent the coordinates of the pixels to be calculated;
acoustic maps are optimally exposed by selecting various methods (absolute, relative, manual, minus_delta, lin/log, all, effective value, peak) to specify the suitable minimum and maximum of a color scale;
synchronization errors of all microphones and amplifier channels are eliminated by compensating the pictures with corresponding parameters from the parameter files of the microphone array and the data recorder;
records of the camera pictures and the associated records of the microphone time functions, time synchronization signals, scene information, and parameter files of the microphone array and the data recorder are stored together with information about this association.

55. Process of claim 54, characterized in that points on the acoustic map have a tuple of delay times determined for them which comprises the delay times of the acoustic signals between the exciting site and the array's microphones.

56. Process of claim 54, characterized in that algebraic combinations of the time functions are executed in such a way that when the microphone channel data is accessed the time delays in an associated tuple are evaluated.

57. Process of claim 54, characterized in that the interference values for points on the acoustic map are visualized for
a time point; or
a sequence of time points.

58. Process of claim 54, characterized in that the time function of a site is calculated for all time points as described in claim 5, and then a single value associated with the site (interference value), especially the mean level of the time function, is determined for the time function by algebraic operations such as, e.g., effective value, maximum, sigmoid, etc.

59. Process of claim 54, characterized in that the result of an algebraic operation such as, e.g., addition, is noted for a time point Tx, for which the common delay time of all channels is eliminated.

60. Process of claim 54, characterized in that, for each microphone of the microphone array, the type, identification sensitivity, coordinates of membrane center (x, y, z), axis orientation (dx, dy, dz), loci of the amplitudes and delay times, and, for the optical camera, the type, aperture, maximum image frequency, and pixel resolutions are stored in a parameter file which is associated with the microphone array and which has an identification number assigned to it, which is referenced with the array's hardware signature.

61. Process of claim 54, characterized in that before a measurement it is possible to check the precise superposition and orientation between an optical image and acoustic image by producing a test sound with a calibration tester, which can check the correct superposition of the camera image and the acoustic map.

62. Device for imaging acoustic objects by recording acoustic maps which have a reference image of the measured object associated with them using a microphone array, which has an optical camera integrated into it so that the two form a unit in which the microphone array, a data recorder, and a data processing device exchange microphone data, camera image(s), and time synchronization information through means of data transfer
characterized in that
the device is set up in such a way that
calculation-relevant parameters of the microphones and the camera of an array are stored in an unmistakable way in an array parameter file; and
synchronization errors of all microphones and amplifier channels are eliminated by compensating the pictures with corresponding parameters from the parameter files of the microphone array and the data recorder.

63. Device of claim 62, characterized in that all microphone data of an array is fed through a common connection (cable or bus) and connected to the data recorder through a common one or more-part plug.

64. Device of claim 62, characterized in that the video camera's lead is also integrated into this common connection line.

65. Device of claim 62, characterized in that a microphone array contains a signature chip in the plug connected to the data recorder.

66. Device of claim 62, characterized in that the data recorder can have a calibration test device connected to it which contains a sound producing device.

67. Device of claim 62, characterized in that a unit consisting of the microphone array and a video camera connected in a non-detachable manner is mounted on a tripod so that it can pivot.

68. Device of claim 62, characterized in that microphone arrays having a different number of channels are pin-compatible, allowing them to be connected to a data recorder through the same one or more-part plug type that is identical for various arrays; unused inputs in the plug can be shorted under some circumstances.

69. Device of claim 62, characterized in that the data recorder is integrated into the microphone array and that this unit is mounted on a tripod so that it can pivot.

70. Device of claim 62, characterized in that a collapsible microphone array for measuring over great distances advantageously consists of a video camera and at least three tubes, which are each equipped with n microphones and which do not lie in a plane and which are connected with at least two joints.

71. Device of claim 62, characterized in that an acoustically transparent microphone array for two-dimensional indoor measurements advantageously consists of a video camera and microphones arranged at equal distances on a ring.

72. Computer program product comprising a computer-readable storage medium that has a program stored on it which, once it has been loaded into a computer's memory, allows the computer to image acoustic objects using a microphone array to record acoustic maps which have a reference image of the measured object associated with them in an imaging process comprising the steps described in claim 54.

73. Computer-readable storage medium that has a program stored on it which, once it has been loaded into a computer's memory, allows the computer to image acoustic objects using a microphone array to record acoustic maps which have a reference image of the measured object associated with them in an imaging process comprising the steps described in claim 54.
